(19) United States
(12) Patent Application Publication
(10) Pub. No.: US 2026/0152400 A1
(43) Pub. Date: Jun. 4, 2026

(54) MULTIFUNCTIONAL FILM HAVING HEAT DISSIPATION AND ELECTROMAGNETIC SHIELDING CAPACITY AND METHOD FOR MANUFACTURING THEREOF

(71) Applicants: HYUNDAI MOTOR COMPANY, Seoul (KR); Kia Corporation, Seoul (KR); Inha University Research and Business Foundation, Incheon (KR)

(72) Inventors: Woongui HWANG, Hwaseong-si (KR); CHANGSOO KIM, Hwaseong-si (KR); SEOK HA, Hwaseong-si (KR); KYONG HWA SONG, Hwaseong-si (KR); Ji Yong PARK, Incheon (KR); Seung Jae YANG, Incheon (KR)

(21) Appl. No.: 19/090,557

(22) Filed: Mar. 26, 2025

(30) Foreign Application Priority Data
Dec. 2, 2024 (KR) 10-2024-0176419

(51) Int. Cl. C01B 32/174; H02M 1/44

(52) U.S. Cl. CPC C01B 32/174; H02M 1/44; C01P 2004/13; C01P 2004/50; C01P 2004/84; C01P 2006/32

(57) ABSTRACT

A multifunctional film includes a heat dissipation layer and an electromagnetic shielding layer. The heat dissipation layer includes carbon nanotubes. The electromagnetic shielding layer is coated on a first side or the first side and a second side of the heat dissipation layer. The electromagnetic shielding layer includes magnetic particles.

### CROSS-REFERENCE TO RELATED APPLICATION

This application claims priority to and the benefit of Korean Patent Application No. 10-2024-0176419, filed on Dec. 2, 2024, the disclosure of which is incorporated herein by reference in its entirety.

### TECHNICAL FIELD

The present disclosure relates to a multifunctional film having heat dissipation and electromagnetic shielding capacity, a power conversion device including the multifunctional film, and an electric vehicle including the power conversion device.

### BACKGROUND

Recently, with the technological transition from internal combustion engine vehicles to electric vehicles, the proportion of electric vehicles has been increasing. Electric vehicles may convert battery power into driving power through power conversion components used for driving. The development of high-performance power conversion devices that may help achieve high output and high electric ratio continues to advance to enhance the performance of electric vehicles.

### SUMMARY

Low-frequency electromagnetic waves may be continuously generated due to alternating current during the power conversion process. These low-frequency electromagnetic waves may not only pose harmful risks to the human body, but may also interfere with other electronic devices in the vehicle, causing a decrease in vehicle performance or failure in severe cases.

In addition, considerable heat may be generated during the power conversion process. As the temperature rises due to the characteristics of power conversion devices, the electrical resistance may increase, resulting in an increase in the power consumption. This not only may cause a decrease in vehicle performance, but also in severe cases, may damage the devices, rendering the system inoperable. Therefore, efficient heat dissipation performance may be needed to address the heat generation issues.

For electromagnetic shielding of power conversion components, a reflective shielding method using a metal case may be applied to large components in a system unit. Efforts to improve in heat dissipation performance may have focused on the design of a heat sink structure or a thermal interface material (TIM). However, since this approach makes it difficult to simultaneously achieve effective electromagnetic shielding and efficient heat dissipation performance, the development of materials with more efficient and integrated heat dissipation and electromagnetic shielding functions may be needed.

Implementations according to present disclosure address the issues described above.

In an aspect, implementations in the present disclosure provides a multifunctional film capable of simultaneously securing excellent electromagnetic shielding performance and heat dissipation performance, and a method for manufacturing the same.

Further, in some aspect, implementations in the present disclosure provides a multifunctional film that can be applied to a green technology field using a power conversion device such as an electric vehicle.

According to one aspect of the subject matter described in this application, a multifunctional film is provided. The multifunctional film includes: a heat dissipation layer containing carbon nanotubes; and an electromagnetic shielding layer coated on one or both sides of the heat dissipation layer, in which the electromagnetic shielding layer contains magnetic particles.

Implementations according to this aspect can include one or more of the following features.

In some examples, the magnetic particles can include at least one metal selected from the group consisting of nickel (Ni), cobalt (Co), iron (Fe), scandium (Sc), titanium (Ti), vanadium (V), chromium (Cr), manganese (Mn), copper (Cu), zinc (Zn), yttrium (Y), zirconium (Zr), niobium (Nb), molybdenum (Mo), technetium (Tc), ruthenium (Ru), rhodium (Rh), palladium (Pd), cadmium (Cd), lanthanum (La), tungsten (W), osmium (Os), iridium (Ir), platinum (Pt), gold (Au), mercury (Hg), samarium (Sm), europium (Eu), gadolinium (Gd), terbium (Tb), dysprosium (Dy), holmium (Ho), aluminum (Al), gallium (Ga), indium (In), germanium (Ge), tin (Sn), lead (Pb), lithium (Li), sodium (Na), potassium (K), rubidium (Rb), cesium (Cs), magnesium (Mg), calcium (Ca), strontium (Sr), and barium (Ba), or ions thereof.

In some implementations, the magnetic particles can be coordinately bonded with organic ligands to form a conductive metal-organic framework (cMOF).

In some implementations, the conductive metal-organic framework can be a two-dimensional (2D) structure.

In some examples, a thickness of the heat dissipation layer can be 100 nm to 3000 nm.

In some implementations, the multifunctional film can further include an adhesive sheet.

According to another aspect of the subject matter described in this application, a method for manufacturing a multifunctional film is provided. The method includes: synthesizing a carbon nanotube sheet using a floating catalyst chemical vapor deposition (FCCVD) method; and coating magnetic particles on the carbon nanotube sheet.

In some examples, synthesizing the carbon nanotube sheet using the FCCVD method can include: introducing a carbon nanotube synthesis material into a reactor; gradually increasing the internal temperature of the reactor to synthesize carbon nanotubes; and agglomerating the carbon nanotubes to be obtained in a sheet form.

In some examples, the carbon nanotube synthesis material can include a carbon source, a catalyst, and an activator.

In some examples, the carbon source can be at least one selected from the group consisting of methane, methanol, ethanol, formaldehyde, acetaldehyde, diethyl ether, 1-propanol, acetone, benzene, toluene, xylene, ethane, propane, butane, pentane, hexane, cyclohexane, ethylene, propylene, and acetylene, the catalyst can be at least one metallocene selected from the group consisting of ferrocene, cobaltocene, nickelocene, chromocene, and vanadocene, and the activator can be any one of thiophene, carbon disulfide, or sulfur (S).

In some implementations, gradually increasing the internal temperature of the reactor can include: increasing the internal temperature of the reactor to a first temperature; increasing the internal temperature of the reactor to a second temperature; and increasing the internal temperature of the reactor to a third temperature, in which the first temperature can be 300° C. to 600° C., the second temperature can be 650° C. to 850° C., and the third temperature can be 900° C. to 1500° C.

In some implementations, coating magnetic particles on the carbon nanotube sheet can be performed using a solvothermal synthesis method.

According to another aspect of the subject matter described in this application, a power conversion device is provided. The power conversion device includes: a power module; a thermal interface material; and the multifunctional film.

As described above and throughout this disclosure, implementations in the present disclosure provides a multifunctional film having excellent electromagnetic shielding performance.

Moreover, implementations in the present disclosure provides a multifunctional film having high heat dissipation performance.

Moreover, implementations in the present disclosure provides a method for manufacturing a multifunctional film capable of continuous process operation and controlling performance as needed.

### BRIEF DESCRIPTION OF THE DRAWINGS

FIG. 1 illustrates an example of SEM image of films of Example 1 (right), Example 2 (middle), and Comparative Example 1 (left).

FIG. 2 illustrates an example of an evaluation result of electromagnetic shielding performance in a high-frequency band of films manufactured according to Example and Comparative Example.

FIG. 3 illustrates an example of an evaluation result of electromagnetic shielding performance in a low-frequency band of films of Example 1 (right) and Comparative Example 1 (left).

FIG. 4 illustrates an example of an evaluation result of electromagnetic shielding performance based on thickness in a low-frequency band of films manufactured according to Example and Comparative Example.

FIG. 5 illustrates an example of an evaluation result of thermal conductivity in a surface transmission direction of a heat dissipation layer including carbon nanotubes.

FIG. 6 illustrates an example of an evaluation result of heat dissipation performance of a heat dissipation layer including carbon nanotubes.

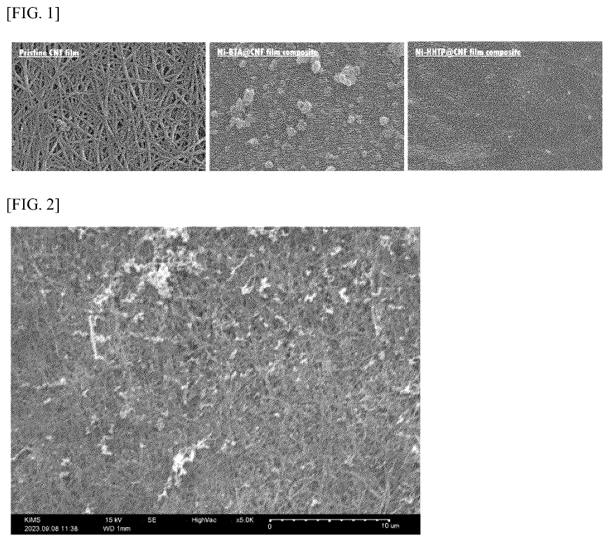

### DETAILED DESCRIPTION

The present disclosure relates to a multifunctional film, a method for manufacturing the same including a heat dissipation layer containing carbon nanotubes, and an electromagnetic shielding layer coated on one or both sides of the heat dissipation layer, in which the electromagnetic shielding layer contains magnetic particles. The heat dissipation layer can impart excellent heat dissipation performance to the multifunctional film due to the ultra-high surface area characteristics due to a porous structure and the material characteristics of the carbon nanotubes. In addition, the electromagnetic shielding layer can effectively absorb or reflect electromagnetic waves in low-frequency and high-frequency bands by including magnetic particles. As such, the multifunctional film of the present disclosure can exhibit excellent heat dissipation performance and electromagnetic shielding performance at the same time, and thus can be used in a power module including a power conversion device required for satisfying high output and high electric ratio, such as an electric vehicle.

The present disclosure provides a multifunctional film including: a heat dissipation layer containing carbon nanotubes; and an electromagnetic shielding layer coated on one or both sides of the heat dissipation layer, in which the electromagnetic shielding layer contains magnetic particles.

In some implementations, the carbon nanotubes can be double-walled carbon nanotubes in terms of securing high durability while exhibiting excellent electrical characteristics, but are not particularly limited thereto.

In some implementations, the heat dissipation layer can be a single layer or a multilayer, but is not limited thereto.

In some examples, the magnetic particles can include at least one metal selected from the group consisting of Ni, Co, Fe, Sc, Ti, V, Cr, Mn, Cu, Zn, Y, Zr, Nb, Mo, Tc, Ru, Rh, Pd, Cd, La, W, Os, Ir, Pt, Au, Hg, Sm, Eu, Gd, Tb, Dy, Ho, Al, Ga, In, Ge, Sn, Pb, Li, Na, K, Rb, Cs, Mg, Ca, Sr and Ba, or ions thereof. Specifically, in terms of enabling the electromagnetic shielding layer to exhibit high permittivity to easily perform reflection and absorption of electromagnetic waves, the magnetic particles can include at least one metal selected from the group consisting of Ni, Co and Fe, or ions thereof.

In some implementations, the magnetic particles can be coordinately bonded with organic ligands to form a conductive metal-organic framework (cMOF). As the magnetic particles form the cMOF, the electromagnetic shielding performance of the electromagnetic shielding layer including the magnetic particles can be further improved.

In some implementations, the organic ligand can be a one-dimensional (1D) organic ligand including substituted or unsubstituted C6 to C30 aryltetramine or a 2D organic ligand including substituted or unsubstituted C6 to C30 arylhexamine. At this time, the 1D organic ligand can mean an organic ligand having a 1D cMOF by forming coordination bonds with the magnetic particles, and the 2D organic ligand can mean an organic ligand having a 2D cMOF by forming coordination bonds with the magnetic particles.

In some implementations, the 1D organic ligand can be any one selected from the group consisting of substituted or unsubstituted benzene-tetramine, substituted or unsubstituted naphthalene-tetramine, substituted or unsubstituted anthracene-tetramine, substituted or unsubstituted tetracene-tetramine, substituted or unsubstituted pentacene-tetramine, substituted or unsubstituted phenanthrene-tetramine, substituted or unsubstituted pyrene-tetramine, substituted or unsubstituted chrysene-tetramine, substituted or unsubstituted perylene-tetramine, substituted or unsubstituted fluorene-tetramine, substituted or unsubstituted coronene-tetramine, and substituted or unsubstituted ovalene-tetramine.

In some implementations, the 2D organic ligand can be any one selected from the group consisting of substituted or unsubstituted benzene-hexamine, substituted or unsubstituted naphthalene-hexamine, substituted or unsubstituted anthracene-hexamine, substituted or unsubstituted tetracene-hexamine, substituted or unsubstituted pentacene hexamine, substituted or unsubstituted phenanthrene-hexamine, substituted or unsubstituted pyrene-hexamine, substituted or unsubstituted chrysene-hexamine, substituted or unsubstituted perylene-hexamine, substituted or unsubstituted fluorene-hexamine, substituted or unsubstituted coronene-hexamine, and substituted or unsubstituted ovalene-hexamine.

The 2D cMOF can have a high specific surface area and a layered structure to promote faster interfacial charge transfer. In addition, the delocalization of charge carriers is facilitated by the expansion of x-conjugation, and the non-covalent interaction between adjacent molecules in the network is strengthened, so that the conductivity is improved, and as a result, the absorption and reflection performance of electromagnetic waves can be further improved.

In some examples, the thickness of the heat dissipation layer can be 100 nm to 3000 nm, specifically 500 nm to 1500 nm, but is not limited thereto as long as the purpose of the present disclosure can be achieved.

In some implementations, the multifunctional film can further include an adhesive sheet. The adhesive sheet can be omitted when the multifunctional film is directly radiated to a power conversion device. Meanwhile, since the adhesive sheet uses a conventional adhesive sheet used in the art of the present disclosure, a detailed description thereof will be omitted.

In addition, the present disclosure provides a method for manufacturing a multifunctional film, including synthesizing a carbon nanotube sheet using a floating catalyst chemical vapor deposition (FCCVD) method; and coating magnetic particles on the carbon nanotube sheet.

The description of the method for manufacturing the multifunctional film is omitted because the content for the multifunctional film is the same as described above.

In some implementations, synthesizing the carbon nanotube sheet using the FCCVD method can include introducing a carbon nanotube synthesis material into a reactor; gradually increasing the internal temperature of the reactor to synthesize carbon nanotubes; and agglomerating the carbon nanotubes to be obtained in a sheet form.

The introducing of the carbon nanotube synthesis material into the reactor is a step of introducing a material for manufacturing a carbon nanotube sheet into the reactor.

The carbon nanotube synthesis material can mean a material for synthesizing carbon nanotubes. In some implementations, the carbon nanotube synthesis material can include a carbon source, a catalyst, and an activator. In some implementations, the carbon nanotube synthesis material can further include an inert gas and a reducing agent.

In some examples, the carbon source can be at least one selected from the group consisting of methane, methanol, ethanol, formaldehyde, acetaldehyde, diethyl ether, 1-propanol, acetone, benzene, toluene, xylene, ethane, propane, butane, pentane, hexane, cyclohexane, ethylene, propylene, and acetylene, the catalyst can be at least one metallocene selected from the group consisting of ferrocene, cobaltocene, nickelocene, chromocene, and vanadocene, and the activator can be any one of thiophene, carbon disulfide, or sulfur(S).

The reducing agent can serve to maintain the activity of the catalyst and prevent excessive carbon deposition. In some implementations, the reducing agent is not particularly limited, but can specifically be hydrogen or carbon monoxide.

Gradually increasing the internal temperature of the reactor can be a step of gradually increasing the internal temperature of the reactor to sequentially pyrolyze carbon nanotube synthesis materials having low pyrolysis temperatures among the carbon source, the catalyst, and the activator, and then synthesizing carbon nanotubes.

In some implementations, gradually increasing the internal temperature of the reactor can include (a) increasing the internal temperature of the reactor to a first temperature; (b) increasing the internal temperature of the reactor to a second temperature; and (c) increasing the internal temperature of the reactor to a third temperature. In step (a), the metal ions generated by the pyrolysis of the metallocene can agglomerate, in step (b), the radicals generated by the pyrolysis of the activator can activate the catalyst, and in step (c), the carbon source can be pyrolyzed to provide carbon atoms constituting the carbon nanotubes.

In some examples, the first temperature can be 300° C. to 600° C., specifically 400° C. to 500° C., the second temperature can be 650° C. to 850° C., specifically 700° C. to 800° C., and the third temperature can be 900° C. to 1500° C., specifically 900° C. to 1200° C., but are not limited thereto.

The agglomerating of the carbon nanotubes to be obtained in the sheet form is a step of agglomerating the synthesized carbon nanotubes into aerogels by cooling to be obtained in the sheet form.

In some implementations, the agglomerating of the carbon nanotubes to be obtained in the sheet form can be performed at 300° C. to 600° C., specifically, 450° C. to 500° C., but is not limited thereto.

In some implementations, the coating of the magnetic particles can be performed using a solvothermal synthesis method. The cMOF can be synthesized using the solvothermal synthesis method, and there is an advantage of having a relatively simple process and synthesizing the cMOF in high yield.

Further, the present disclosure provides a power conversion device including a power module; a thermal interface material; and the multifunctional film.

The power module and the thermal interface material can be any of those commonly used in the manufacture of the power conversion device.

Hereinafter, Examples and Comparative Examples will be described. However, the following Examples are merely examples of implementations of the present disclosure, and the present disclosure is not limited to the following Examples.

### Example 1

### (1) Preparation of Carbon Nanotube Sheet

Methane, ferrocene, thiophene, hydrogen, and argon gases were injected into the reactor from the top. The internal temperature of the reactor was heated to 450° C., 850° C., and 1200° C. in sequence to synthesize carbon nanotubes using an FCCVD method. Next, the internal temperature of the reactor was cooled to 450° C. to aerogelize the carbon nanotubes. The carbon nanotubes in the aerogel structure synthesized at the bottom of the reactor were obtained using a cylinder until the thickness became 500 nm, thereby preparing carbon nanotubes in a sheet form.

### (2) Coating of Magnetic Particles

A mixed solution was prepared by adding 1.175 g of Ni(NO₃)₂·6H₂O and 0.650 g of 2,3,6,7,10,11-hexahydroxytriphenylene (HHTP) to 500 ml of a solvent mixed with water and DMF in a volume ratio of 1:1. The carbon nanotubes obtained in the sheet form were immersed in the mixed solution and reacted at 85° C. for 18 hours. After the reaction, the carbon nanotubes were washed twice with ethanol and then vacuum-dried to prepare a multifunctional film.

### Example 2

A multifunctional film was manufactured in the same manner as in Example 1, except that a mixed solution was prepared by mixing 1.295 g of NiCl₂·6H₂O and 1.420 g of benzene-1,2,4,5-tetramine (BTA)·4HCl in 500 ml of water, and then carbon nanotubes obtained in the sheet form were immersed in the mixed solution and stirred and reacted at room temperature for 3 hours.

### Example 3

A multifunctional film was manufactured in the same manner as in Example 1, except that three sheets of carbon nanotubes manufactured in the sheet form having a thickness of 500 nm were laminated to form a total thickness of 1500 nm.

### Example 4

A multifunctional film was manufactured in the same manner as in Example 1, except that carbon nanotubes in an aerogel structure were obtained using a cylinder until the thickness became 1500 nm.

### Comparative Example 1

A film was manufactured in the same manner as in Example 1, except that magnetic particles were not coated.

### Comparative Example 2

A film was manufactured in the same manner as in Example 3, except that magnetic particles were not coated.

### Comparative Example 3

A film was manufactured in the same manner as in Example 4, except that magnetic particles were not coated.

### Experimental Example 1: Evaluation of Electromagnetic Shielding Performance

In order to evaluate the electromagnetic shielding performance of the multifunctional films manufactured in Examples and Comparative Examples above, shielding effectiveness (SE) including both electromagnetic reflection and electromagnetic absorption was measured at high frequency (12.4 GHz and 26.5 GHZ) and low frequency bands, respectively, and the results were shown in FIGS. 2 to 4, respectively. In FIGS. 2 to 4, SER refers to SE_{reflection} and SEA refers to SE_{absorption}. Meanwhile, the experiments were performed twice to obtain accurate results.

As can be seen in FIG. 2, compared to Comparative Example 1 (pristine) without coating magnetic particle in the high frequency band, Example 1 (Ni_HHTP) coated with a 2D cMOF showed improved shielding performance of 5 to 6 dB, and Example 2 (Ni_BTA) coated with a 1D cMOF showed improved shielding performance of about 1 dB.

In the low frequency band, the shielding performance was evaluated for Examples coated with the 2D cMOF, which showed relatively excellent shielding performance in the high frequency band among Examples.

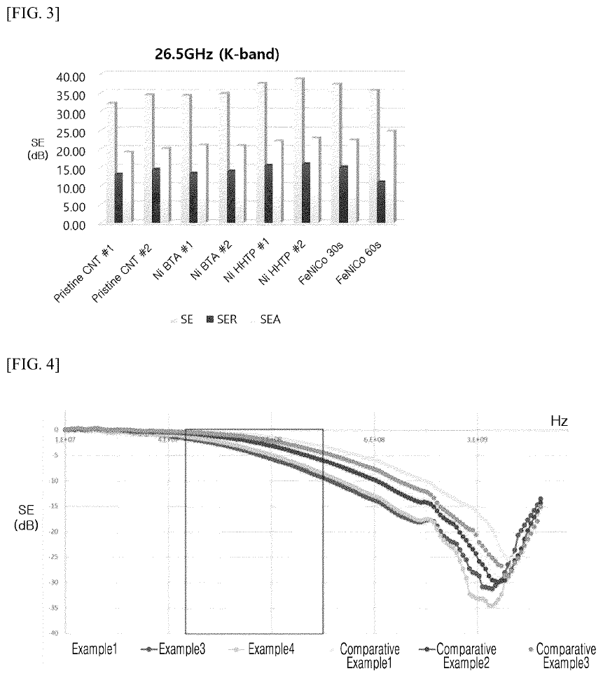

As can be seen in FIG. 3, compared to Comparative Example 1 without coating the magnetic particles in the low frequency band, Example 1 coated with the 2D cMOF showed improved shielding performance of 1 dB while maintaining the reflection characteristics and improving the absorption characteristics.

In addition, as can be seen in FIG. 4, when the laminating thickness increased from 500 nm to 1500 nm, the shielding performance was improved by about 3 to 4 dB.

### Experimental Example 2: Evaluation of Heat Dissipation Performance

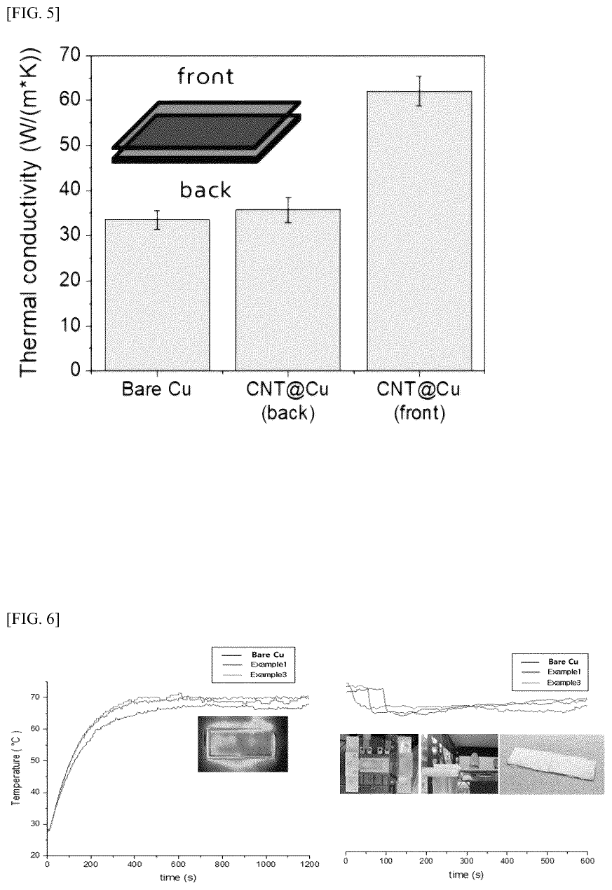

First, the thermal conductivity in a surface transmission direction of the heat dissipation layer containing CNT was measured using a thermal wave method, and the results were shown in FIG. 5.

As can be seen in FIG. 5, when the film manufactured in Comparative Example 1 was coated, the thermal conductivity was 62.1 W/mK, which was about twice greater than bare Cu of 33.5 W/mK and an uncoated surface of 33.7 W/mK.

Next, a power conversion device was used to evaluate the heat dissipation performance of the heat dissipation layer included in the multifunctional film of the present disclosure. The experiment was conducted as follows. A convergence temperature was measured by applying voltage to the power module. A pure Cu plates and Cu plates attached with the films of Examples 1 and 3 were prepared, and applied to the power module with TIM, and then the convergence temperature was measured by applying voltage, and the results were shown in Table 1 and FIG. 6, respectively.

TABLE 1

| | Convergence temperature (° C.) | |
|---|---|---|
| | Before attachment of heat | After attachment of heat |
| | dissipation layer | dissipation layer |
| Cu | 69.2 | 66.9 |
| Example 1 | 70.5 | 65.2 |
| Example 3 | 70 | 65.4 |

As can be seen from Table 1 and FIG. 6, when the heat dissipation layer according to Example of the present disclosure was applied, heat dissipation was actively performed due to improved thermal conductivity, and the convergence temperature was lowered compared to pure Cu without applying the heat dissipation layer.

Features, structures, effects, and the like described in the above-described implementations are included in at least one implementation of the present disclosure, and are not necessarily limited to one implementation. Furthermore, the features, structures, effects, and the like illustrated in each implementation can be combined or modified even in other implementations by those of ordinary skill in the art to which the implementations pertain. Accordingly, the contents related to these combinations and modifications should be interpreted to cover the scope of the present disclosure.

What is claimed is:

1. A multifunctional film comprising:
a heat dissipation layer comprising carbon nanotubes; and
an electromagnetic shielding layer coated on a first side or the first side and a second side of the heat dissipation layer,
wherein the electromagnetic shielding layer comprises magnetic particles.

2. The multifunctional film of claim 1, wherein the magnetic particles comprise one or more metals selected from a group consisting of nickel (Ni), cobalt (Co), iron (Fe), scandium (Sc), titanium (Ti), vanadium (V), chromium (Cr), manganese (Mn), copper (Cu), zinc (Zn), yttrium (Y), zirconium (Zr), niobium (Nb), molybdenum (Mo), technetium (Tc), ruthenium (Ru), rhodium (Rh), palladium (Pd), cadmium (Cd), lanthanum (La), tungsten (W), osmium (Os), iridium (Ir), platinum (Pt), gold (Au), mercury (Hg), samarium (Sm), europium (Eu), gadolinium (Gd), terbium (Tb), dysprosium (Dy), holmium (Ho), aluminum (Al), gallium (Ga), indium (In), germanium (Ge), tin (Sn), lead (Pb), lithium (Li), sodium (Na), potassium (K), rubidium (Rb), cesium (Cs), magnesium (Mg), calcium (Ca), strontium (Sr), and barium (Ba), or ions thereof.

3. The multifunctional film of claim 1, wherein the magnetic particles of the electromagnetic shielding layer form coordination bonds with organic ligands to thereby form a conductive metal-organic framework (cMOF).

4. The multifunctional film of claim 3, wherein the cMOF has a two-dimensional (2D) structure.

5. The multifunctional film of claim 1, wherein a thickness of the heat dissipation layer is greater than or equal to 100 nm and less than or equal to 3000 nm.

6. The multifunctional film of claim 1, further comprising:
an adhesive sheet.

7. A method for manufacturing a multifunctional film comprising:
synthesizing a carbon nanotube sheet using a floating catalyst chemical vapor deposition (FCCVD) method; and
coating the carbon nanotube sheet with magnetic particles.

8. The method for manufacturing the multifunctional film of claim 7, wherein synthesizing the carbon nanotube sheet using the FCCVD method comprises:
introducing a carbon nanotube synthesis material into a reactor;
gradually increasing an internal temperature of the reactor to synthesize carbon nanotubes; and
agglomerating the carbon nanotubes to thereby form one or more sheets of the carbon nanotubes.

9. The method for manufacturing the multifunctional film of claim 8, wherein the carbon nanotube synthesis material comprises a carbon source, a catalyst, and an activator.

10. The method for manufacturing the multifunctional film of claim 9, wherein the carbon source comprises one or more chemical compounds selected from a group consisting of methane, methanol, ethanol, formaldehyde, acetaldehyde, diethyl ether, 1-propanol, acetone, benzene, toluene, xylene, ethane, propane, butane, pentane, hexane, cyclohexane, ethylene, propylene, and acetylene,
wherein the catalyst comprises one or more metallocenes selected from a group consisting of ferrocene, cobaltocene, nickelocene, chromocene, and vanadocene, and
wherein the activator comprises one of thiophene, carbon disulfide, or sulfur(S).

11. The method for manufacturing the multifunctional film of claim 8, wherein gradually increasing the internal temperature of the reactor comprises:
increasing the internal temperature of the reactor to a first temperature,
increasing the internal temperature of the reactor to a second temperature, and
increasing the internal temperature of the reactor to a third temperature, and
wherein the first temperature is greater than or equal to 300° C. and less than or equal to 600° C.,
wherein the second temperature is greater than or equal to 650° C. and less than or equal to 850° C., and
wherein the third temperature is greater than or equal to 900° C. and less than or equal to 1500° C.

12. The method for manufacturing the multifunctional film of claim 7, wherein coating the carbon nanotube sheet with the magnetic particles is performed using a solvothermal synthesis method.

13. A power conversion device comprising:
a power module;
a thermal interface material; and
a multifunctional film comprising:
a heat dissipation layer comprising carbon nanotubes, and
an electromagnetic shielding layer coated on a first side or the first side and a second side of the heat dissipation layer,
wherein the electromagnetic shielding layer comprises magnetic particles.

14. The power conversion device of claim 13, wherein the magnetic particles of the electromagnetic shielding layer comprise one or more metals selected from a group consisting of nickel (Ni), cobalt (Co), iron (Fe), scandium (Sc), titanium (Ti), vanadium (V), chromium (Cr), manganese (Mn), copper (Cu), zinc (Zn), yttrium (Y), zirconium (Zr), niobium (Nb), molybdenum (Mo), technetium (Tc), ruthenium (Ru), rhodium (Rh), palladium (Pd), cadmium (Cd), lanthanum (La), tungsten (W), osmium (Os), iridium (Ir), platinum (Pt), gold (Au), mercury (Hg), samarium (Sm), europium (Eu), gadolinium (Gd), terbium (Tb), dysprosium (Dy), holmium (Ho), aluminum (Al), gallium (Ga), indium (In), germanium (Ge), tin (Sn), lead (Pb), lithium (Li), sodium (Na), potassium (K), rubidium (Rb), cesium (Cs), magnesium (Mg), calcium (Ca), strontium (Sr), and barium (Ba), or ions thereof.

15. The power conversion device of claim 13, wherein the magnetic particles of the electromagnetic shielding layer form coordination bonds with organic ligands to thereby form a conductive metal-organic framework (cMOF).

16. The power conversion device of claim 15, wherein the cMOF has a two-dimensional (2D) structure.

17. The power conversion device of claim 13, wherein a thickness of the heat dissipation layer is greater than or equal to 100 nm and less than or equal to 3000 nm.

18. The power conversion device of claim 13, wherein the multifunctional film further comprises an adhesive sheet.
